(19) United States
(12) Patent Application Publication
(10) Pub. No.: US 2025/0226443 A1
(43) Pub. Date: Jul. 10, 2025

(54) GEL POLYMER MATERIALS AND METHODS OF MAKING AND USE THEREOF

(71) Applicant: VIRGINIA TECH INTELLECTUAL PROPERTIES, INC., Blacksburg, VA (US)

(72) Inventors: Deyang Yu, Emeryville, CA (US); Louis A. Madsen, Blacksburg, VA (US)

(21) Appl. No.: 19/015,914

(22) Filed: Jan. 10, 2025

Related U.S. Application Data
(60) Provisional application No. 63/619,439, filed on Jan. 10, 2024.

(51) Int. Cl. H01M 10/0565

(52) U.S. Cl. CPC H01M 10/0565; H01M 2300/0082; H01M 2300/0085

(57) ABSTRACT

In one aspect, the disclosure relates to gel polymer compositions and articles comprising gel polymer compositions. In one aspect, the gel polymer compositions comprise: a first polymer comprising poly(ethylene glycol), poly(pentyl malonate), or a derivative thereof; poly(2,2′-disulfonyl-4,4-benzidine terephthalamide) (PBDT); and a salt. The disclosure also relates to methods for forming compositions disclosed herein, comprising: dissolving both a salt and a first polymer in a first solvent, thereby forming a first mixture; dissolving PBDT in a second solvent, thereby forming a second mixture; combining the first mixture and the second mixture, thereby forming an intermediate mixture; pouring the intermediate mixture onto a substrate; drying the intermediate mixture and the substrate; and removing the dried intermediate mixture from the substrate, thereby forming a polymer membrane. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/619,439, filed on Jan. 10, 2024, which is incorporated herein by reference in its entirety.

### STATEMENT REGARDING FEDERALLY SPONSORED RESEARCH OR DEVELOPMENT

This invention was made with government support under grant no. DE-EE0008860 and grant no. DE-AC05-76RL01830 awarded by the Department of Energy. The Government has certain rights in the invention.

### BACKGROUND

Development of all-solid-state batteries and other similar devices, such as transistors, relies at least in part on electrolyte materials with good mechanical and electrical properties, such as wide temperature range durability and fast ion transport. One set of potential electrolyte materials are gel polymers, though they suffer from problems that make practical application challenging. Despite advances in gel polymer and polymer electrolyte research, there is still a scarcity of polymer compositions that exhibit good electrical and mechanical properties over a variety of temperature conditions. These needs and other needs are satisfied by the present disclosure.

### SUMMARY

In accordance with the purpose(s) of the disclosure, as embodied and broadly described herein, the disclosure, in one aspect, relates to gel polymer compositions comprising: a first polymer comprising poly(ethylene glycol), poly(pentyl malonate), or a derivative thereof; poly(2,2′-disulfonyl-4,4′-benzidine terephthalamide) (PBDT); and a salt. The disclosure also relates to methods for forming compositions disclosed herein, comprising: dissolving both a salt and a first polymer in a first solvent, thereby forming a first mixture; dissolving PBDT in a second solvent, thereby forming a second mixture; combining the first mixture and the second mixture, thereby forming an intermediate mixture; pouring the intermediate mixture onto a substrate; drying the intermediate mixture and the substrate; and removing the dried intermediate mixture from the substrate, thereby forming a polymer membrane. In another aspect, the disclosure also relates to articles, such as batteries or components of batteries, comprising the gel polymer compositions.

Other systems, methods, features, and advantages of the present disclosure will be or will become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a representative composition of a rigid polymer electrolyte and the chemical structures of its components, comprising PBDT, LiTFSI, PEGDME (Mₙ=500 g mol-1).

FIG. 1B shows an atomic force microscopy phase image of a representative rigid polymer electrolyte.

FIG. 1C depicts a slice of a representative rigid polymer electrolyte sandwiched between a 25×25×25 mm NdFeB magnet and a stack of thin NdFeB magnet disks (16 pieces with a total thickness of 13 mm.

FIG. 1D depicts a representative rigid polymer electrolyte membrane disk set between two steel plates and without any other coin cell parts before (top) and after (bottom) compression.

FIG. 1E shows representative storage and loss tensile moduli as a function of temperature.

FIG. 1F shows representative thermogravimetric analysis using a step heating process.

FIG. 1G shows differential scanning calorimetry characterization of a representative rigid polymer electrolyte.

FIG. 2 shows a scanning electron microscope image of a representative rigid gel polymer electrolyte membrane.

FIG. 3 shows uniaxial stress-strain test of a representative rigid polymer electrolyte membrane, where the membrane is elastic with a Young's modulus of 580 MPa until it breaks at a tensile strength of 7 MPa.

FIG. 4 shows thermogravimetric analysis traces of PEGDME, a representative liquid electrolyte (LiTFSI dissolved in PEGDME in a mass ratio of 28:64), and a representative solid-state rigid polymer electrolyte under a heating rate of 10° C. min⁻¹ in a N₂ atmosphere.

FIG. 5A shows temperature dependence of the self-diffusion coefficients of PEGDME (¹H), TFSI⁻ (¹⁹F), and Li⁺ (⁷Li) in a representative rigid polymer electrolyte and a comparable representative liquid electrolyte (with LiTFSI and PEGDME mixed in a mass ratio of 28:64).

FIG. 5B shows Arrhenius plots of the ionic conductivity, σ^{EIS}, measured by electrochemical impedance spectroscopy of a representative rigid polymer electrolyte and a corresponding representative liquid electrolyte.

FIG. 5C shows Li⁺ transference number measurement of a representative rigid polymer electrolyte using the DC polarization technique.

FIG. 5D shows a representative comparison of Li⁺ transference number obtained from various techniques: DC polarization (t^{DC}), diffusion NMR (t^{NMR}), and electrophoretic NMR (t^{ENMR}).

FIG. 5E shows an electrophoretic NMR measurement of a representative liquid electrolyte at 25° C.

FIG. 5F shows Onsager transport coefficients of a representative liquid electrolyte normalized by the total ionic conductivity (σ^{EIS}) at 25° C.

FIGS. 6A-6B shows 1D ¹⁹F (FIG. 6A) and ⁷Li FIG. 6B) NMR spectra of a representative liquid electrolyte at 25° C.

FIGS. 6C-6D shows 1D ¹⁹F (FIG. 6C) and ⁷Li FIG. 6D) NMR spectra of a representative rigid polymer electrolyte at 25° C.

FIGS. 7A-7B show an electrochemical impedance spectroscopy fit (FIG. 7A) to the semicircle of the Nyquist plots shown in FIG. 2C to extract bulk resistance (R1), solid electrolyte interphase layer resistance (R2), and charge transfer resistance (R3) and the equivalent circuit (FIG. 7B).

FIG. 8A shows a voltage profile of a representative Li/Li cell cycled at various current densities.

FIG. 8B shows typical voltage profiles of a representative Li/LiFePO₄ cell cycled at different current densities.

FIG. 8C shows specific charge and discharge capacities of representative LiFePO₄ at various current densities.

FIGS. 9A-9B shows cyclic voltammetry plots of a representative rigid gel polymer electrolyte at 25° C. (FIG. 9A) and 120° C. (FIG. 9B) using aluminum foil as the working electrode and lithium metal as the counter and reference electrode.

FIG. 10A shows rate capabilities of a representative Li/LiFePO₄ cell at 80° C. and 120° C.

FIGS. 10B-10C shows representative Li/LiFePO₄ cells cycled at 80° C. and 1 mA cm⁻² (FIG. 10A) and 120° C. and 2 mA cm⁻² (FIG. 10B) for 100 cycles followed by cycling at ambient temperature.

FIGS. 11A-11B shows voltage profiles of a representative Li/LiFePO₄ cell when cycling at 80° C. (FIG. 11A) and 120° C. (FIG. 11B) using various current densities.

FIG. 12A shows representative Li/LiFePO₄ voltage profiles of 6 cycles with charging at 80° C. using a current density of 1.0 mA cm⁻², followed by cooling and discharging at 27° C. using a current density of 0.1 mA cm⁻².

FIG. 12B shows corresponding coulombic efficiency and energy efficiency of FIG. 5A cycling tests.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a salt,” “a polymer,” or “a polymer derivative,” includes, but is not limited to, two or more such salts, polymer, or polymer derivatives, and the like.

Reference to “a/an” chemical compound refers to one or more molecules of the chemical compound rather than being limited to a single molecule of the chemical compound. Furthermore, the one or more molecules may or may not be identical, so long as they fall under the category of the chemical compound.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, “ambient temperature” refers to a temperature of 27° C.±1° C.

Unless otherwise specified, temperatures referred to herein are based on atmospheric pressure (i.e. one atmosphere).

### B. Abbreviations

EIS electrochemical impedance spectroscopy
ENMR electrophoretic NMR
LiTFSI lithium bis(trifluoromethylsulfonyl)imide
MICs molecular ionic composites
NdFeB neodymium-iron-boron
NMR nuclear magnetic resonance
PBDT poly(2,2′-disulfonyl-4,4′-benzidine terephthalamide)
PEGDME poly(ethylene glycol) dimethyl ether
PEO poly(ethylene oxide)
Tg glass transition temperature

### C. Gel Polymer Compositions

Disclosed herein are various gel polymer compositions that demonstrate a wide temperature stability range, good strength and stiffness, and non-flammability. The compositions can exhibit good mechanical properties, such as tensile strength, loss modulus, and tensile storage modulus. These compositions can optionally be used as components in batteries, such as all-solid-state batteries, and other electronic articles, such as transistors. In one aspect, the battery component comprising the compositions can be the electrolyte. Batteries comprising the compositions disclosed herein can exhibit fast charging at high temperatures and slower discharging at ambient temperature.

In one aspect, disclosed herein is a gel polymer composition, comprising: a first polymer comprising poly(ethylene glycol), poly(pentyl malonate), or a derivative thereof; poly(2,2′-disulfonyl-4,4′-benzidine terephthalamide) (PBDT); and a salt. The PBDT can comprise PBDT nanofibrils. The PBDT nanofibrils can have an average fibril width of about 1 nm to about 30 nm, about 1 nm to about 25 nm, about 1 nm to about 20 nm, about 1 nm to about 15 nm, about 1 nm to about 10 nm, about 5 nm to about 30 nm, about 5 nm to about 25 nm, about 5 nm to about 20 nm, about 5 nm to about 15 nm, about 8 nm to about 15 nm, or about 3 nm to about 7 nm. The first polymer can have a number average molecular weight of about 150 g/mol to about 8000 g/mol, about 150 g/mol to about 6000 g/mol, about 150 g/mol to about 4000 g/mol, about 150 g/mol to about 2000 g/mol, about 350 g/mol to about 8000 g/mol, about 350 g/mol to about 6000 g/mol, about 350 g/mol to about 4000 g/mol, about 350 g/mol to about 2000 g/mol, or about 400 g/mol to about 8000 g/mol. In a further aspect, the first polymer can comprise a poly(ethylene glycol) derivative selected from poly(ethylene glycol) dimethyl ether, poly(ethylene oxide), poly(oligo-oxyethylenemethacrylate), and a combination thereof. The salt can include a lithium salt, a sodium salt, or a combination thereof. In a further aspect, the salt can comprise a lithium salt such as lithium bis(trifluoromethane)sulfonimide, lithium bis(fluorosulfonyl)imide, lithium trifluoromethanesulfonate, lithium difluoro (oxalato) borate, lithium difluorobis(oxalate) phosphate, lithium perchlorate, or lithium dicyanamide. In a further aspect, the salt can comprise a sodium salt such as sodium bis(trifluoromethane)sulfonimide, sodium bis(fluorosulfonyl)imide, sodium trifluoromethanesulfonate, sodium difluoro (oxalato) borate, sodium difluorobis(oxalate) phosphate, or sodium dicyanamide.

In one aspect, PBDT can comprise from about 2 wt % to about 20 wt %, about 2 wt % to about 16 wt %, about 2 wt % to about 12 wt %, about 2 wt % to about 8 wt %, about 4 wt % to about 20 wt %, about 4 wt % to about 16 wt %, about 4 wt % to about 12 w %, about 6 wt % to about 16 wt %, about 6 wt % to about 12 wt %, or about 6 wt % to about 9 wt % of the total composition. In another aspect, the first polymer can comprise from about 50 wt % to about 80 wt %, about 56 wt % to about 72 wt %, about 50 wt % to about 76 wt %, about 50 wt % to about 76 wt %, about 50 wt % to about 72 wt %, about 50 wt % to about 69 wt %, about 53 wt % to about 80 wt %, about 53 wt % to about 76 wt %, about 53 wt % to about 72 wt %, about 53 wt % to about 69 wt %, about 56 wt % to about 80 wt %, about 56 wt % to about 76 wt %, about 56 wt % to about 72 wt %, about 56 wt % to about 69 wt %, about 61 wt % to about 80 wt %, about 61 wt % to about 72 wt %, or about 61 wt % to about 69 wt % of the total composition. In another aspect, the salt can comprise from about 10 wt % to about 50 wt %, about 10 wt % to about 40 wt %, about 10 wt % to about 31 wt %, about 15 wt % to about 50 wt %, about 15 wt % to about 40 wt %, about 15 wt % to about 31 wt %, about 20 wt % to about 50 wt %, about 20 wt % to about 37 wt %, about 20 wt % to about 31 wt %, or about 25 wt % to about 31 wt % of the total composition.

The disclosed gel polymer compositions can have robust thermomechanical properties. Properties such as tensile strength, loss modulus, and tensile storage modulus can be measured using dynamic mechanical analysis. To measure loss modulus and tensile storage modulus, in one aspect, the composition can be first heated to an elevated temperature (e.g., 150° C.) and the loss and storage moduli can then be measured at various temperatures, e.g., from about 0° C. to about 200° C. or from about 0° C. to about 150° C., while cooling the composition (e.g., at a rate of 2° C. min⁻¹) and while using an oscillation frequency of 1 Hz and a strain amplitude of 0.2%. In one aspect, the composition can have a tensile strength in the transverse or in-plane direction of at least about 4 MPa, at least about 5 MPa, at least about 6 MPa, or at least about 7 MPa. In a further aspect, the composition can have a tensile strength (in the transverse or in-plane direction of about 5 MPa to about 15 MPa, about 5 MPa to about 12 MPa, or about 5 MPa to about 9 MPa. In one aspect, the tensile strength is measured by stress-strain analysis (uniaxial stretching) at a temperature of about 30° C. In another aspect, the composition can have a tensile storage modulus of greater than about 300 MPa, greater than about 400 MPa, or greater than about 500 MPa at a temperature of about 25° C. In another aspect, the composition can have a tensile storage modulus of about 300 MPa to about 800 MPa, about 400 MPa to about 800 MPa, about 500 MPa to about 800 MPa, about 300 MPa to about 700 MPa, about 400 MPa to about 700 MPa, about 400 MPa to about 600 MPa, or about 500 MPa to about 600 MPa at a temperature of about 25° C. In another aspect, the composition can have a tensile storage modulus of greater than about 200 MPa or greater than about 300 MPa at a temperature of about 150° C. In another aspect, the composition can have a tensile storage modulus of about 200 MPa to about 500 MPa, about 200 MPa to about 400 MPa, or about 200 MPa to about 300 MPa at a temperature of about 150° C. In another aspect, the composition can have a loss modulus that is at least about 6 times, about 8 times, or about 10 times lower than a tensile storage modulus of the composition over a temperature range of about 25° C. to about 150° C. In another aspect, the composition can have a loss modulus that is about 10 times to about 30 times, about 10 times to about 25 times, about 10 times to about 20 times, about 10 times to about 15 times, about 15 times to about 30 times, about 15 times to about 25 times, or about 15 times to about 20 times lower than a tensile storage modulus of the composition over a temperature range of about 25° C. to about 150° C.

### D. Methods of Making Gel Polymer Compositions

Also disclosed herein are methods of making any one of the gel polymer compositions disclosed herein. In one aspect, the method of making can comprise a solvent casting method. More specifically, the method of making can comprise: dissolving both a salt and a first polymer in a first solvent, thereby forming a first mixture; dissolving PBDT in a second solvent, thereby forming a second mixture; combining the first mixture and the second mixture, thereby forming an intermediate mixture; pouring the intermediate mixture onto a substrate; drying the intermediate mixture and the substrate; and removing the dried intermediate mixture from the substrate, thereby forming a polymer membrane. The first polymer can comprise poly(ethylene glycol), poly(pentyl malonate), or a derivative thereof. In a further aspect, the first mixture and the second mixture can be combined to form the intermediate mixture at a temperature above room temperature, for example about 60° C. to about 100° C. or about 80° C. to about 90° C. In another further aspect, the intermediate mixture can be allowed to equilibrate at the elevated temperature for a period of time (e.g., about 1 hour to about 24 hours). In one aspect, the substrate can be a glass substrate. In a further aspect, the intermediate mixture and the substrate can be dried at a temperature above room temperature, for example about 60° C. to about 100° C., about 80° C. to about 100° C., or about 70° C. to about 90° C., for a period of time (e.g., about 1 hour to about 48 hours). The method can further comprise drying the polymer membrane by vacuum drying. In one aspect, the vacuum drying can be done at a temperature above room temperature (e.g., about 80° C. to about 120° C.) for at least about 5 minutes (e.g., about 5 minutes to about 5 days).

The first solvent and the second solvent can be individually selected from water, methanol, ethanol, isopropyl alcohol, acetic acid, dichloromethane, tetrahydrofuran, ethyl acetate, acetonitrile, dimethylformamide, dimethyl sulfoxide, acetone, hexamethylphosphoramide, ethylene glycol, other common organic solvents known in the art of organic synthesis, and a combination thereof. The first polymer can have a number average molecular weight of about 150 g/mol to about 8000 g/mol, about 150 g/mol to about 6000 g/mol, about 150 g/mol to about 4000 g/mol, about 150 g/mol to about 2000 g/mol, about 350 g/mol to about 8000 g/mol, about 350 g/mol to about 6000 g/mol, about 350 g/mol to about 4000 g/mol, about 350 g/mol to about 2000 g/mol, or about 400 g/mol to about 8000 g/mol. In a further aspect, the first polymer can comprise a poly(ethylene glycol) derivative selected from poly(ethylene glycol) dimethyl ether, poly(ethylene oxide), poly(oligo-oxyethylenemethacrylate), and a combination thereof. The salt can be a lithium salt, a sodium salt, or a combination thereof. In a further aspect, the salt can comprise lithium bis(trifluoromethane)sulfonimide, lithium bis(fluorosulfonyl)imide, lithium trifluoromethanesulfonate, lithium difluoro (oxalato) borate, lithium difluorobis(oxalate) phosphate, lithium perchlorate, or lithium dicyanamide. In a further aspect, the salt can be a sodium salt such as sodium bis(trifluoromethane)sulfonimide, sodium bis(fluorosulfonyl)imide, sodium trifluoromethanesulfonate, sodium difluoro (oxalato) borate, sodium difluorobis(oxalate) phosphate, or sodium dicyanamide.

In one aspect, PBDT or PBDT nanofibrils can comprise from about 2 wt % to about 20 wt %, about 2 wt % to about 16 wt %, about 2 wt % to about 12 wt %, about 2 wt % to about 8 wt %, about 4 wt % to about 20 wt %, about 4 wt % to about 16 wt %, about 4 wt % to about 12 w %, about 6 wt % to about 16 wt %, about 6 wt % to about 12 wt %, or about 6 wt % to about 9 wt % of the polymer membrane. In another aspect, the first polymer can comprise from about 50 wt % to about 80 wt %, about 56 wt % to about 72 wt %, about 50 wt % to about 76 wt %, about 50 wt % to about 76 wt %, about 50 wt % to about 72 wt %, about 50 wt % to about 69 wt %, about 53 wt % to about 80 wt %, about 53 wt % to about 76 wt %, about 53 wt % to about 72 wt %, about 53 wt % to about 69 wt %, about 56 wt % to about 80 wt %, about 56 wt % to about 76 wt %, about 56 wt % to about 72 wt %, about 56 wt % to about 69 wt %, about 61 wt % to about 80 wt %, about 61 wt % to about 72 wt %, or about 61 wt % to about 69 wt % of the polymer membrane. In another aspect, the salt can comprise from about 10 wt % to about 50 wt %, about 10 wt % to about 40 wt %, about 10 wt % to about 31 wt %, about 15 wt % to about 50 wt %, about 15 wt % to about 40 wt %, about 15 wt % to about 31 wt %, about 20 wt % to about 50 wt %, about 20 wt % to about 37 wt %, about 20 wt % to about 31 wt %, or about 25 wt % to about 31 wt % of the polymer membrane.

### E. Aspects

The following listing of exemplary aspects supports and is supported by the disclosure provided herein.
Aspect 1. A gel polymer composition, comprising: a first polymer comprising poly(ethylene glycol), poly(pentyl malonate), or a derivative thereof; poly(2,2′-disulfonyl-4,4′-benzidine terephthalamide) (PBDT); and a salt.
Aspect 2. The gel polymer composition of aspect 1, wherein the PBDT comprises PBDT nanofibrils.
Aspect 3. The gel polymer composition of aspect 1 or aspect 2, wherein the PBDT nanofibrils have an average fibril width of about 1 nm to about 30 nm.
Aspect 4. The gel polymer composition of any one of aspects 1-3, wherein the salt is selected from a lithium salt, a sodium salt, and a combination thereof.
Aspect 5. The gel polymer composition of aspect 4, wherein the salt comprises a lithium salt selected from lithium bis(trifluoromethane)sulfonimide, lithium bis(fluorosulfonyl)imide, lithium trifluoromethanesulfonate, lithium difluoro (oxalato) borate, lithium difluorobis(oxalate) phosphate, lithium perchlorate, lithium dicyanamide, and a combination thereof.
Aspect 6. The gel polymer composition of aspect 4, wherein the salt comprises a lithium salt selected from lithium bis(trifluoromethane)sulfonimide, lithium bis(fluorosulfonyl)imide, and a combination thereof.
Aspect 7. The gel polymer composition of any one of aspects 4-6, wherein the salt comprises a sodium salt selected from sodium bis(trifluoromethane)sulfonimide, sodium bis(fluorosulfonyl)imide, sodium trifluoromethanesulfonate, sodium difluoro (oxalato) borate, sodium difluorobis(oxalate) phosphate, sodium dicyanamide, and a combination thereof.
Aspect 8. The gel polymer composition of any one of aspects 1-7, wherein the first polymer has a number average molecular weight of about 150 g/mol to about 8000 g/mol.
Aspect 9. The gel polymer composition of any one of aspects 1-7, wherein the first polymer has a number average molecular weight of about 150 g/mol to about 2000 g/mol.
Aspect 10. The gel polymer composition of any one of aspects 1-9, wherein the first polymer comprises a poly(ethylene glycol) derivative selected from poly(ethylene glycol) dimethyl ether, poly(ethylene oxide), poly(oligo-oxyethylenemethacrylate), and a combination thereof.
Aspect 11. The gel polymer composition of any one of aspects 1-10, wherein PBDT comprises about 2 wt % to about 20 wt % of the total composition.
Aspect 12. The gel polymer composition of any one of aspects 1-11, wherein first polymer comprises about 50 wt % to about 80 wt % of the total composition.
Aspect 13. The gel polymer composition of any one of aspects 1-12, wherein the salt comprises about 10 wt % to about 50 wt % of the total composition.
Aspect 14. The gel polymer composition of any one of aspects 1-13, wherein the composition has a tensile strength in the transverse direction of at least about 4 MPa, where the tensile strength is measured by stress-strain analysis at a temperature of about 30° C.
Aspect 15. The gel polymer composition of any one of aspects 1-14, wherein the composition has a tensile strength in the transverse direction of about 4 MPa to about 15 MPa, where the tensile strength is measured by stress-strain analysis at a temperature of about 30° C.
Aspect 16. The gel polymer composition of any one of aspects 1-15, wherein the composition has a tensile storage modulus of greater than about 300 MPa at about 25° C., where the tensile storage modulus is measured at an oscillation frequency of 1 Hz and a strain amplitude of 0.2%.
Aspect 17. The gel polymer composition of any one of aspects 1-16, wherein the composition has a tensile storage modulus of about 300 MPa to about 800 MPa at about 25° C., where the tensile storage modulus is measured at an oscillation frequency of 1 Hz and a strain amplitude of 0.2%.
Aspect 18. The gel polymer composition of any one of aspects 1-17, wherein the composition has a tensile storage modulus of greater than about 200 MPa at about 150° C., where the tensile storage modulus is measured at an oscillation frequency of 1 Hz and a strain amplitude of 0.2%.
Aspect 19. The gel polymer composition of any one of aspects 1-18, wherein the composition has a tensile storage modulus of about 200 MPa to about 500 MPa at about 150° C., where the tensile storage modulus is measured at an oscillation frequency of 1 Hz and a strain amplitude of 0.2%.
Aspect 20. The gel polymer composition of any one of aspects 1-19, wherein a loss modulus of the composition is at least about 6 times lower than a storage modulus of the composition over a temperature range about 25° C. to about 150° C., where both the tensile storage modulus and the loss modulus are measured at an oscillation frequency of 1 Hz and a strain amplitude of 0.2%.
Aspect 21. The gel polymer composition of any one of aspects 1-20, wherein a loss modulus of the composition is from about 10 times to about 30 times lower than a storage modulus of the composition over a temperature range about 25° C. to about 150° C., where both the tensile storage modulus and the loss modulus are measured at an oscillation frequency of 1 Hz and a strain amplitude of 0.2%.
Aspect 22. A method, comprising: dissolving both a salt and a first polymer in a first solvent, thereby forming a first mixture, where the first polymer comprises poly(ethylene glycol), poly(pentyl malonate), or a derivative thereof; dissolving poly(2,2′-disulfonyl-4,4′-benzidine terephthalamide) (PBDT) in a second solvent, thereby forming a second mixture; combining the first mixture and the second mixture, thereby forming an intermediate mixture; pouring the intermediate mixture onto a substrate; drying the intermediate mixture and the substrate; and removing the dried intermediate mixture from the substrate, thereby forming a polymer membrane.
Aspect 23. The method of aspect 22, wherein the polymer membrane comprises

PBDT nanofibrils.
Aspect 24. The method of aspect 22 or aspect 23, wherein the PBDT nanofibrils have an average fibril width of about 1 nm to about 30 nm.
Aspect 25. The method of any one of aspects 22-24, wherein the salt is selected from a lithium salt, a sodium salt, and a combination thereof.
Aspect 26. The method of aspect 25, wherein the salt comprises a lithium salt selected from lithium bis(trifluoromethane)sulfonimide, lithium bis(fluorosulfonyl)imide, lithium trifluoromethanesulfonate, lithium difluoro (oxalato) borate, lithium difluorobis(oxalate) phosphate, lithium perchlorate, lithium dicyanamide, and a combination thereof.
Aspect 27. The method of aspect 25, wherein the salt comprises a lithium salt selected from lithium bis(trifluoromethane)sulfonimide, lithium bis(fluorosulfonyl)imide, and a combination thereof.
Aspect 28. The method of any one of aspects 25-27, wherein the salt comprises a sodium salt selected from sodium bis(trifluoromethane)sulfonimide, sodium bis(fluorosulfonyl)imide, sodium trifluoromethanesulfonate, sodium difluoro (oxalato) borate, sodium difluorobis(oxalate) phosphate, sodium dicyanamide, and a combination thereof.
Aspect 29. The method of any one of aspects 22-28, wherein the first polymer has a number average molecular weight of about 150 g/mol to about 8000 g/mol.
Aspect 30. The method of any one of aspects 22-29, wherein the first polymer has a number average molecular weight of about 150 g/mol to about 2000 g/mol.
Aspect 31. The method of any one of aspects 22-30, wherein the first polymer comprises a poly(ethylene glycol) derivative selected from poly(ethylene glycol) dimethyl ether, poly(ethylene oxide), poly(oligo-oxyethylenemethacrylate), and a combination thereof.
Aspect 32. The method of any one of aspects 22-31, wherein PBDT comprises about 2 wt % to about 20 wt % of the polymer membrane.
Aspect 33. The method of any one of aspects 22-32, wherein first polymer comprises about 50 wt % to about 80 wt % of the polymer membrane.
Aspect 34. The method of any one of aspects 22-34, wherein the salt comprises about 10 wt % to about 50 wt % of the polymer membrane.
Aspect 35. The method of any one of aspects 22-35, further comprising drying the polymer membrane by vacuum drying.
Aspect 36. The method of any one of aspects 22-36, wherein the first mixture and the second mixture are combined at a temperature of about 60° C. to about 100° C.
Aspect 37. A gel polymer composition produced by the method of any one of aspects 22-36.
Aspect 38. An article comprising the gel polymer composition of any one of aspects 1-21 or 37.
Aspect 39. The article of aspect 38, wherein the article comprises a battery or a component of a battery.
Aspect 40. The article of aspect 39, wherein the battery is a solid-state battery.
Aspect 41. The article of aspect 39 or aspect 40, wherein the component of the battery is an electrolyte.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### F. Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Gel Electrolytes Built from a Charged Double Helical Polymer

Introduction. Development of next-generation all-solid-state lithium metal batteries relies on a thin solid-state electrolyte that can enable fast Li⁺ transport and intimate electrode/electrolyte contact, along with having wide temperature range durability. Fast charging requires high ionic conductivity and low electrode/electrolyte interfacial resistance. Wide temperature range durability of a solid electrolyte reduces the complexity of temperature control/feedback units, for example, in battery packs for electric vehicles. Instead, this thermal range durability takes efficient advantage of joule heating generated during fast charging since higher temperatures enable faster charging rates. PEO and many other polymers have been studied as polymer electrolytes. However, due to the coupling between ionic conductivity and glass transition temperature (T_{g}), as well as the high degree of crystallinity, Li⁺ transport in dry polymer electrolytes is sluggish. In contrast, gel polymer electrolytes prepared by adding a large amount of liquid plasticizers to dry polymer electrolytes demonstrate much higher ionic conductivity, but with a significant compromise of mechanical properties, especially at elevated temperatures, thus preventing their application over a wide temperature range.

Polymers with rigid backbones have shown great success in recent years in achieving both high ionic conductivity and strong mechanical properties. MICs prepared from ionic liquids and a rigid-rod polyamide, poly(2,2′-disulfonyl-4,4′-benzidine terephthalamide) (PBDT), have successfully pushed the limits of polymer electrolytes simultaneously towards significantly higher conductivity, stronger mechanical properties, and wider working temperature windows.

### Results and Discussion—Morphological, Mechanical and Thermal Properties.

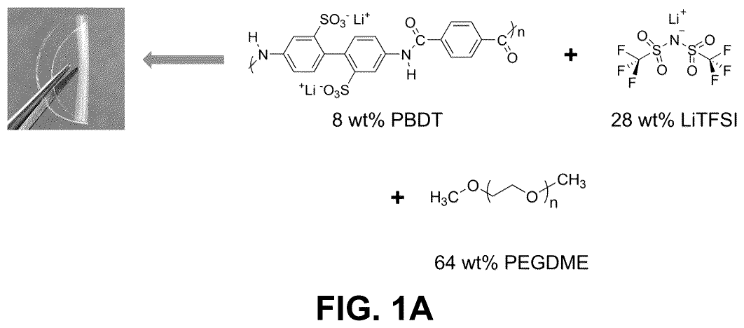

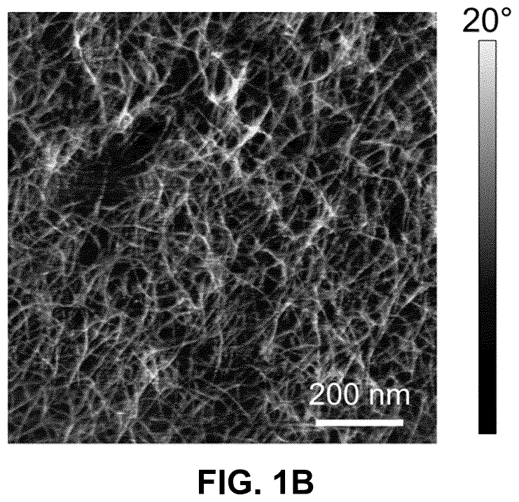

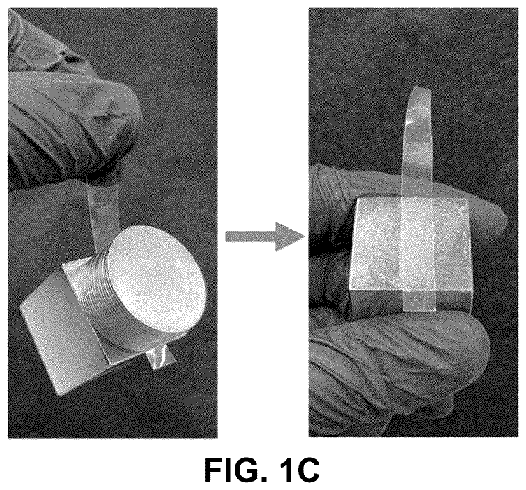

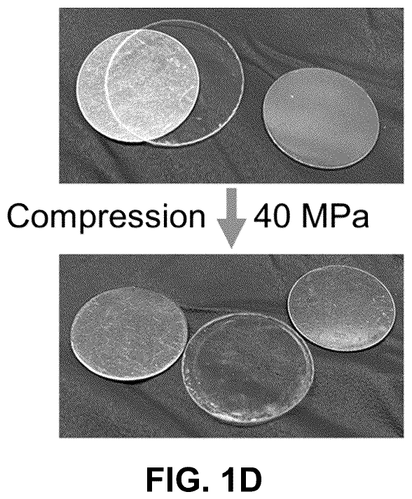

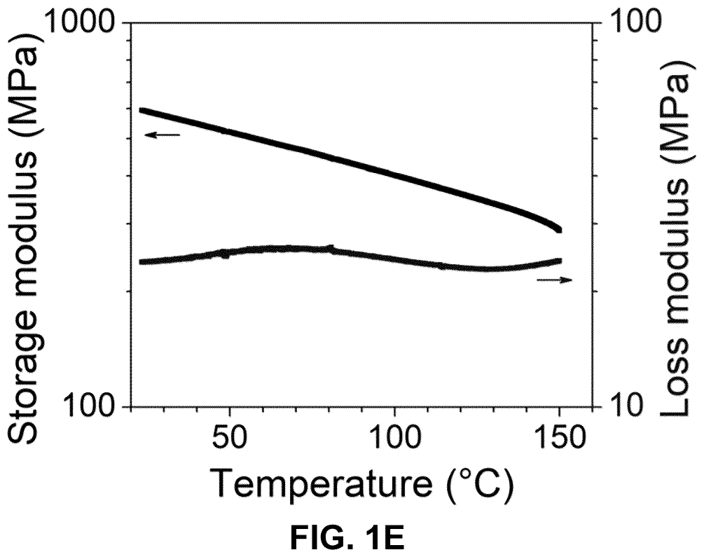

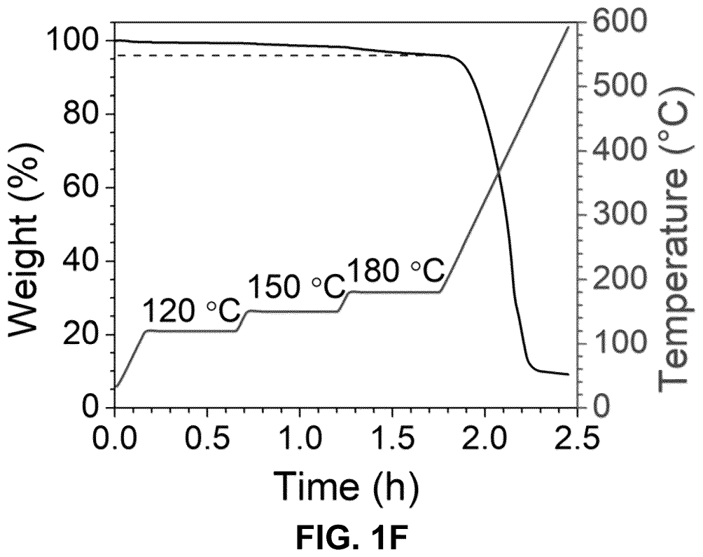

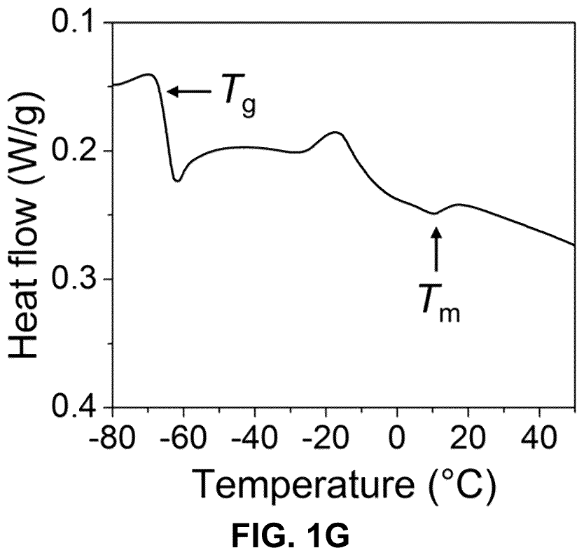

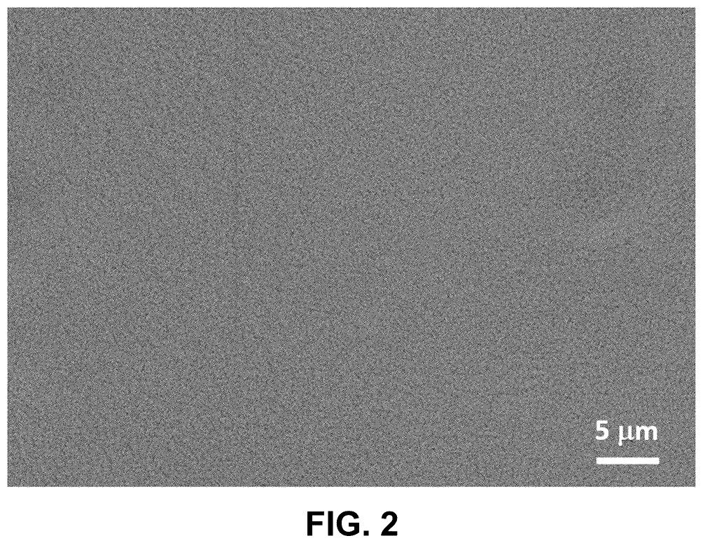

PBDT is a rigid aromatic polyamide with two sulfonate groups per repeat unit (FIG. 1A). In aqueous solution, two PBDT chains self-assemble into a double helix that further enhances the rigidity and charge density along the polymer rods. The solid-state PBDT-LiTFSI-PEGDME rigid gel polymer electrolyte is prepared using a solvent casting method to achieve the composition shown in FIG. 1A. The obtained membrane is uniform and homogenous (FIG. 2). Atomic force microscopy reveals the presence of a percolated PBDT-rich fibrillar network with an average fibril width of 5 nm (FIG. 1B). The partially ordered electrostatic (ion-ion) interactions between PBDT sulfonate groups and PEGDME-solvated Li⁺ (and salt counterions) are the main driving forces for formation of these PBDT-rich nanofibrils. The extremely high rigidity of PBDT double helices further inhibits dissolution of PBDT in PEGDME due to insignificant favorable entropy gain, assisting the formation of PBDT-rich nanofibrils. This nanofibrillar network serves as a nanoscopic sponge that solidifies the liquid LiTFSI PEGDME electrolyte into a free-standing solid-state electrolyte and endows robust thermomechanical properties, even with the presence of only 8 wt % PBDT in the material.

Practical solid-state polymer electrolytes require exquisite mechanical robustness. To intuitively evaluate whether the prepared rigid polymer electrolyte with only 8 wt % PBDT is mechanically suitable as a separator in a lithium battery, a slice of the solvent-casted membrane was sandwiched between NdFeB magnets (FIG. 1C). The membrane has a thickness of 0.11 mm and a width of 7.0 mm, and the total mass of the magnets is 170 g. Under an extensional stress of 2.2 MPa and a compression of 1.1 MPa, the membrane does not break or crush and shows no obvious deformation after separating the magnets. Note that the stack stress during lithium pouch cell operation is on the order of 1 MPa. Further evaluation shows that the membrane can survive even 40 MPa compression without damage (FIG. 1D). Only <1% of liquid (PEGDME and LiTFSI) squeezes out from the membrane. Indeed, this small layer of liquid electrolyte can improve the interfacial contact between the solid-state electrolyte and electrodes in solid-state batteries, thus reducing electrode/electrolyte interfacial resistance.

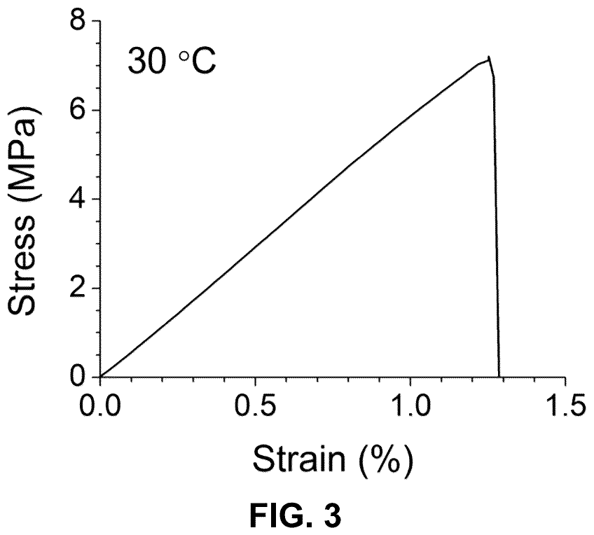

Dynamic mechanical analysis was then used to further characterize the tensile moduli of the rigid polymer electrolyte as a function of temperature (FIG. 1E). The tensile storage modulus reaches 590 MPa at 25° C. and drops only slightly to 290 MPa when heated to 150° C. The loss modulus is lower than the storage modulus by a factor of >10 even at 150° C., demonstrating that the membrane remains a stiff solid material at 150° C. The storage and loss tensile moduli show that the high rigidity of the rigid polymer electrolyte is nearly temperature independent. Uniaxial stress-strain testing at 30° C. reveals a high tensile strength up to 7 MPa (FIG. 3). These superior thermomechanical properties, arising at least in part from the PBDT-rich nanofibrillar network, make these materials drastically different from conventional gel polymer electrolytes. For comparison, typical PEO-lithium salt electrolyte membranes typically break at a stress below 2 MPa under extension and show a Young's modulus only ˜10 MPa. Gel polymer electrolytes show even weaker mechanical robustness and many gel polymer electrolytes melt under moderate heating. The high tensile strength of the rigid polymer electrolyte compares favorably to the tensile strength of commercial Celgard separators in the transverse direction (6-12 MPa). The storage modulus of the rigid polymer electrolyte also matches that of Celgard even in the machine direction when immersed in electrolytes (400-800 MPa). However, the modulus of Celgard drops significantly with temperature, thus making it unsuitable for high temperature (>80° C.) applications. These comparisons indicate that the rigid polymer electrolyte with as low as 8 wt % PBDT can serve as a separator in all-solid-state batteries even up to 150° C.

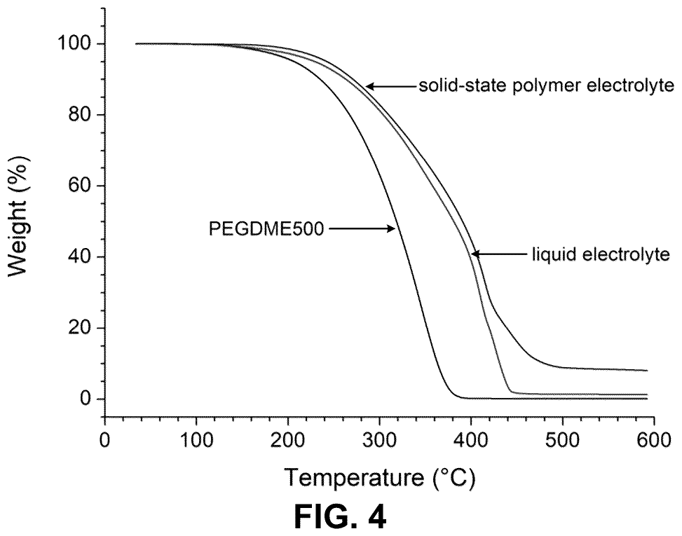

Thermogravimetric analysis further characterizes the thermal stability of the rigid polymer electrolyte (FIG. 1F). The material shows negligible mass loss after heating at 120° C. for 0.5 hour and 150° C. for 0.5 hour consecutively, with only 4% mass loss after further heating at 180° C. for 0.5 hour. The excellent thermal stability of the rigid polymer electrolyte originates from the low volatility of PEGDME, as well as the interactions between PEGDME and the other components, PBDT and LiTFSI (FIG. 4). The negligible vapor pressure of PEGDME also results in non-flammability. Differential scanning calorimetry study reveals that the glass transition occurs at −67° C. (FIG. 1G), which is 20° C. lower than the high molecular weight PEO/LiTFSI system at a similar EO: Li⁺ ratio. In addition, the low melting temperature, 11° C., further enables high ionic conductivity and ambient temperature applications of the rigid polymer electrolyte. In contrast, PEO-based electrolytes only work at 60° C.-100° C. in general. Overall, the low T_{g} and melting point, extremely low volatility, and superior thermomechanical properties make this rigid polymer electrolyte a competitive solid-state electrolyte for applications over a wide temperature range.

### Results and Discussion—Ion Transport Dynamics and Mechanism.

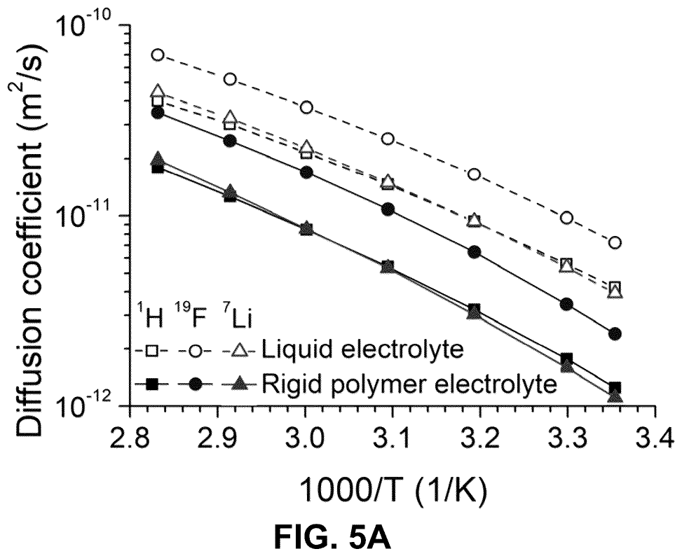

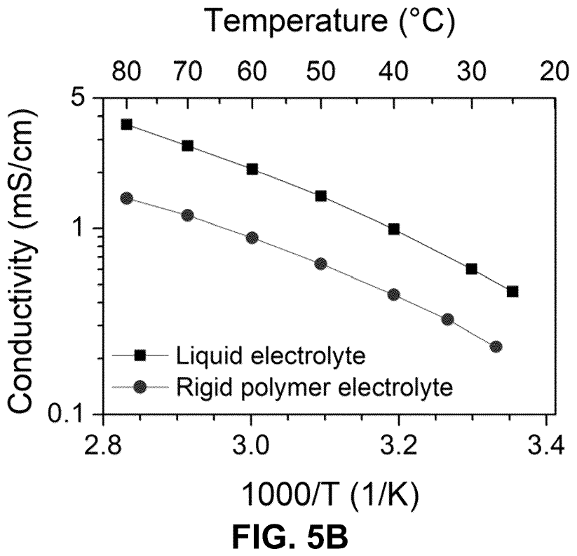

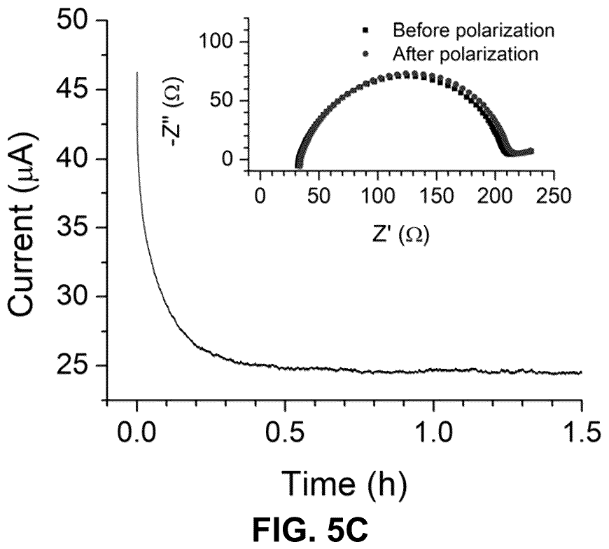

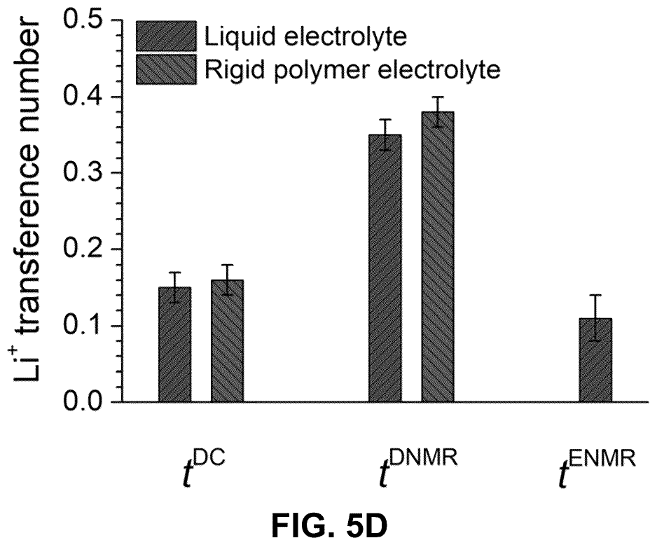

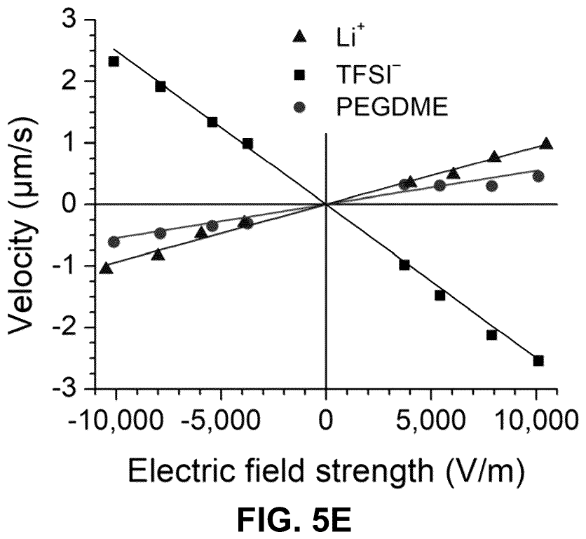

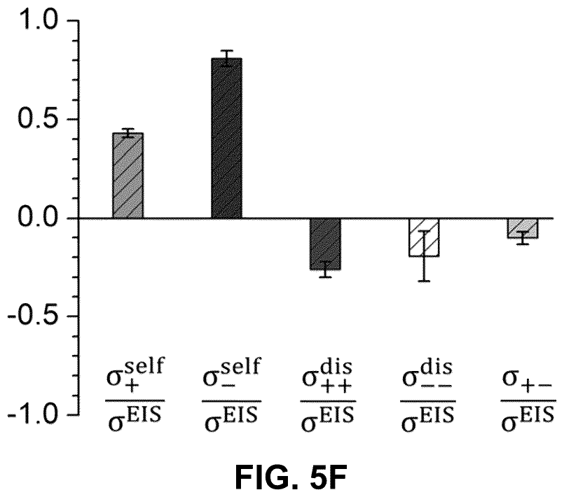

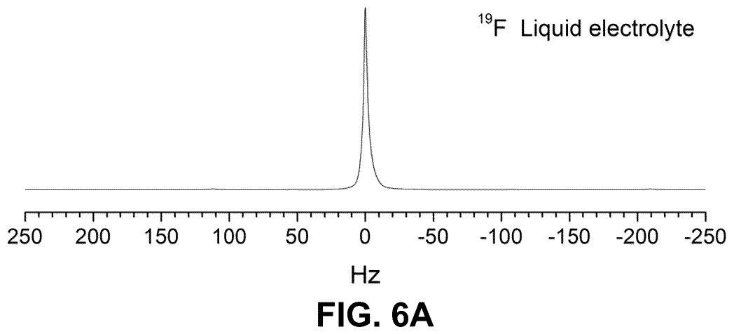

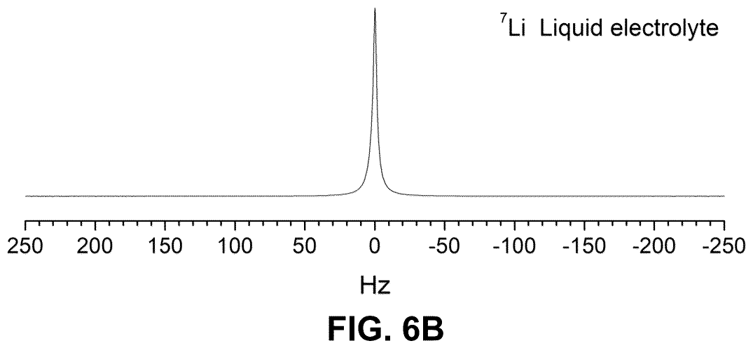

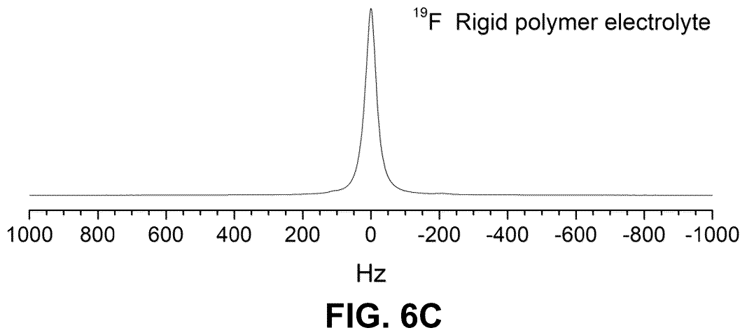

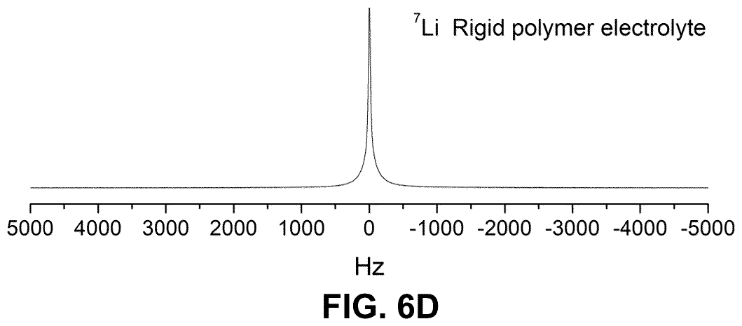

Next, species-specific self-diffusion coefficients were combined with ionic conductivity to study ion transport dynamics. FIG. 5A shows the diffusion coefficients of Li⁺, TFSI⁻, and PEGDME in the rigid polymer electrolyte compared to a liquid mixture of LiTFSI and PEGDME prepared in the same ratio as in the rigid polymer electrolyte. In both electrolytes, TFSI⁻ is the fastest diffusing species while Li⁺ is diffusing at nearly the same rate as PEGDME. At 25° C., Li⁺ diffuses slightly slower than PEGDME, which is surprising considering that PEGDME (10-11 EO units) would expectedly have a larger hydrodynamic radius. This suggests that Li⁺ and ether groups of PEGDME form strong interactions and diffuse together in the so-called “vehicular” mechanism. When comparing the rigid polymer electrolyte with the liquid electrolyte, the presence of PBDT only slows the diffusion coefficients of Li⁺, TFSI⁻, and PEGDME by a factor of 2.0 to 3.5 in the temperature range 25° C.-80° C. The ionic conductivity of the rigid polymer electrolyte is 0.23 mS cm⁻¹ at 27° C. and 1.4 mS cm⁻¹ at 80° C. (FIG. 5B), and the conductivity of the liquid electrolyte is higher by a factor of 2.2 to 2.5, agreeing well with the diffusion results. This agreement also confirms that the measured diffusion coefficients for the rigid polymer electrolyte represent all moving species both within and outside the PBDT-rich fibrils, due to the 5 nm width of the fibrils and the fast dynamic exchange between the fibril phase and PEGDME-rich phase. See FIGS. 6A-6D for further analysis of the NMR spectra. It is important to note that the self-diffusion coefficient of Li⁺ (D_{Li+}) in this rigid gel polymer electrolyte at 25° C. is 1.1×10⁻¹² m² s⁻¹, which is one order of magnitude higher than high molecular weight EO-unit-based amorphous systems, such as poly(oligo-oxyethylene methacrylate) (POEM) homopolymer and its block copolymers. Such a high D_{Li+} ensures fast lithium ion transport in this rigid gel polymer electrolyte.

Referring to FIGS. 6A-6D, the liquid electrolyte shows narrow peaks in ¹⁹F and ⁷Li spectra, and the width of the peaks are dominated by magnetic field homogeneity. The rigid polymer electrolyte shows only one peak in the ¹⁹F spectrum with a full width at half maximum of 38 Hz. In the ⁷Li spectrum, the rigid polymer electrolyte also shows only one peak with a full width at half maximum of 44 Hz, and the minimal broadening of the bottom part of this peak does not clearly indicate the presence of quadrupole coupling, which would be caused by the locally aligned PBDT rigid-rod polymer chains. The NMR spectra of the rigid polymer electrolyte demonstrate that only one averaged environment of Li⁺ and TFSI⁻ is detected by NMR and thus, the species inside the PBDT-rich nano-fibrils and in the PEGDME-rich phase are exchanging rapidly. In the diffusion measurements, the diffusion length of species during the diffusion time (Δ) is >500 nm. While the width of the PBDT-rich nano-fibrils revealed by atomic force microscopy characterization is on the order of 5 nm, also indicating that the measured diffusion coefficients represent all of the corresponding nuclei in the material.

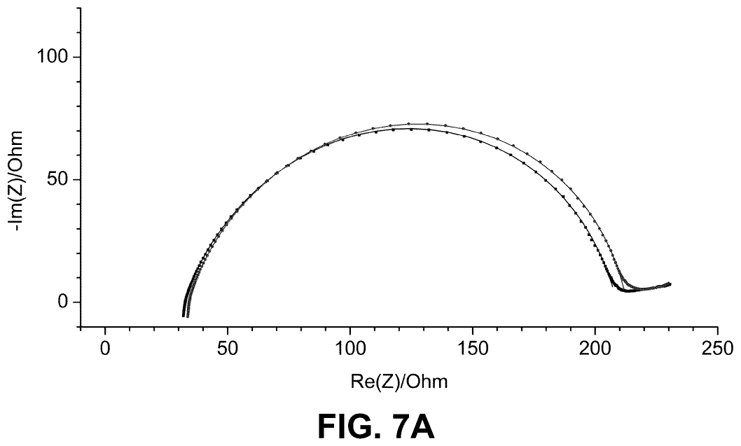

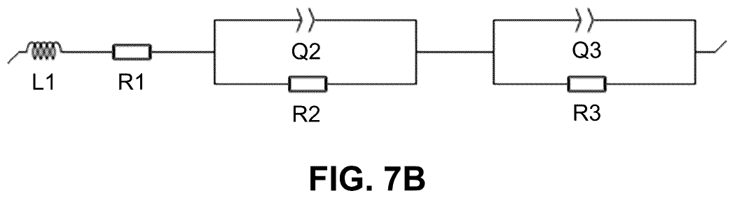

In order to characterize the contribution of Li⁺ to the total ionic conductivity, the Li⁺ transference number was measured using the DC polarization technique (t^{DC}), see FIG. 5C, and t^{DC} was compared with the Li⁺ transference number obtained from diffusion coefficients (t^{DNMR}). The rigid polymer electrolyte and the liquid electrolyte show similar t^{DC} and t^{DNMR} (see FIG. 5D), indicating that the sulfonate groups on PBDT do not significantly slow down Li+transport kinetics. However, both the liquid electrolyte and the rigid polymer electrolyte show a much lower t^{DC} compared to t^{DNMR}, which could relate to the dominant vehicular Li⁺ transport mechanism. FIG. 7A shows an electrochemical impedance spectroscopy fit to the semicircle of the Nyquist plots shown in FIG. 5C to extract bulk resistance (R1), solid electrolyte interphase layer resistance (R2), and charge transfer resistance (R3). FIG. 7B is the equivalent circuit. The sum of R2 and R3 is used as the interfacial resistance to calculate the transference number.

ENMR was performed on the liquid electrolyte to further reveal the Li⁺ transport mechanism since it is challenging to prepare ENMR samples for solid-state materials. Because PBDT sulfonate groups do not significantly slow down Li⁺ transport and the rigid polymer electrolyte consists up to 92 wt % PEGDME500-LiTFSI liquid electrolyte, the information obtained from the liquid electrolyte should be still very valuable. ENMR measures the migration velocity of species in an electric field. FIG. 5E shows the migration velocity of Li⁺, TFSI⁻, and PEGDME in the liquid electrolyte at 25° C. as a function of electric field strength. Electrophoretic mobility u for each species from the slope of corresponding velocity vs. electric field plot. Li⁺ and TFSI⁻ migrate towards different directions in the electric field, as the signs of their slopes are opposite. The mobility of Li⁺ (μ₊) equals 9.4×10⁻¹¹ m² s⁻¹ V⁻¹, while TFSI⁻ shows a higher value μ₋=2.5×10⁻¹⁰ m² s⁻¹ V⁻¹. The charge-neutral PEGDME also migrates in the same direction as Li⁺, with μₛₒₗᵥ=5.5×10⁻¹¹ m² s⁻¹ V⁻¹. This supports that Li⁺ and PEGDME form a long-lived complex and migrate together. Note that the lithium salt concentration in this liquid electrolyte is 1.4 mol L-1, and the molar ratio of ether groups with Li⁺ is 15:1. It has been previously observed that μ for Li⁺ and tetraglyme are nearly identical in an equimolar mixture of LiTFSI and tetraglyme. Note that the chain length of PEGDME used here is double that of tetraglyme, and yet the vehicular mechanism still dominates Li⁺ transport. The substantial velocity of PEGDME relative to Li⁺ ultimately causes a low Li⁺ transference number obtained from ENMR results, t^{ENMR}, of 0.11 in the solvent frame, agreeing reasonably well with t^{DC}. In contrast to the vehicular mechanism, Li⁺ hopping represents motion uncorrelated with the solvent. Salt-in-glycerol electrolytes exemplify hopping, while in most soft materials Li⁺ transport is a combination of vehicular and hopping mechanisms.

To gain further insight into the Li⁺ transport mechanism in the rigid polymer electrolyte, dynamic ionic correlations in the liquid PEGDME-LiTFSI electrolyte are analyzed. In the framework of the Onsager reciprocal relations and linear response theory, the ionic conductivity is:

$$σ = {σ}_{+}^{self} + {σ}_{+ +}^{diss} + {σ}_{-}^{self} + {σ}_{--}^{diss} - 2 {σ}_{+ -} \qquad ( 1 )$$

where σ₊^{self} and σ₋^{self} relate to the diffusion coefficients of Li⁺ and TFSI⁻ via the Nernst-Einstein equation, and the distinct transport coefficient terms σ₊₊^{diss}, σ₋₋^{diss} and σ₊₋ describe the dynamic Li⁺-Li⁺, TFSI⁻-TFSI⁻, and Li⁺-TFSI⁻ directional correlations. When the motions of two species correlate, the corresponding distinct term is positive and they tend to move towards the same direction. FIG. 5F shows these five transport coefficients normalized by the overall ion conductivity, demonstrating that the motions of cations and anions in the electrolytes are strongly anti-correlated. The negative σ₊₊^{diss} and σ₋₋^{diss} highlight the electrostatic repulsions between ions with the same charge. However, their amplitudes are substantial relative to σ₊^{self}, and the substantial negative o₊₊^{diss} is a major reason for the low t^{DC} and t^{ENMR}. Surprisingly, σ₊₋ is also negative. Negative σ₊₋ has been reported in ionic liquids and other highly concentrated electrolytes and is attributed to momentum conservation. It has been pointed out that the motion of all diffusing species in an electrolyte is coupled due to the constraints of charge neutrality and incompressibility of the electrolyte. In this electrolyte, the diffusion of a PEGDME-solvated Li⁺, with a large hydrodynamic radius, to a new location leaves a large free volume behind and will thus drive mobile species to diffuse in the opposite direction to fill that volume. This ionic correlation analysis indicates that using shorter PEGDME chains and reducing lithium salt concentration in future studies may lead to increased σ₊^{self} as well as less negative distinct transport coefficients, ultimately boosting Li⁺ transport dynamics and Li⁺ transference number.

Although the Li⁺ transference number in the rigid gel polymer electrolyte is relatively low, this does not necessarily lead to poor battery rate performance. In reality, Li⁺ mass transport through the electrolyte has significant contributions from convection, diffusion, and migration. A low Li⁺ transference number can be compensated by fast diffusion and/or convection, and thus D_{Li+} plays a major role. The high D_{Li+} in this rigid gel polymer electrolyte at room temperature thus ensures fast overall Li⁺ transport rate in battery cells incorporating this electrolyte.

### Results and Discussion—Solid-state Lithium Battery Performance.

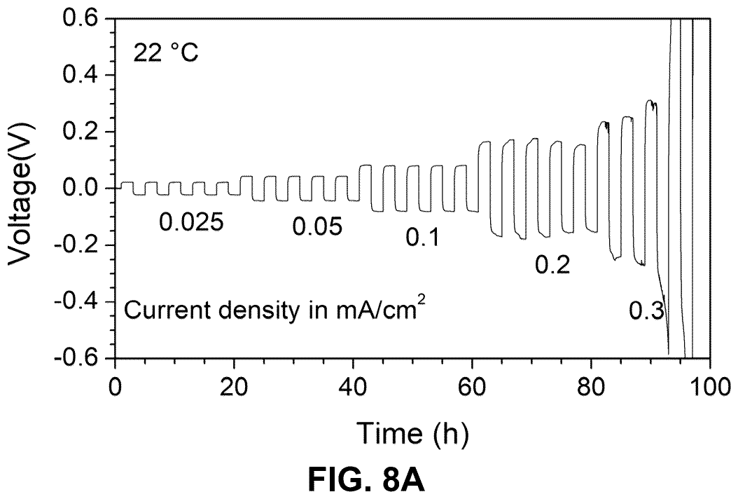

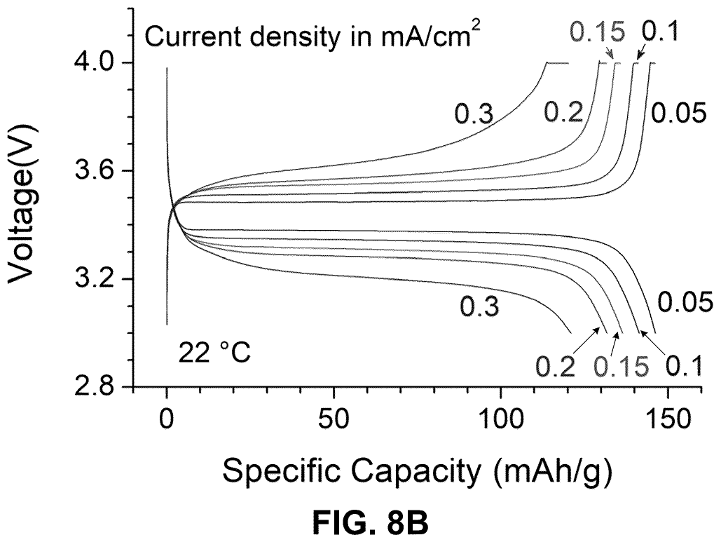

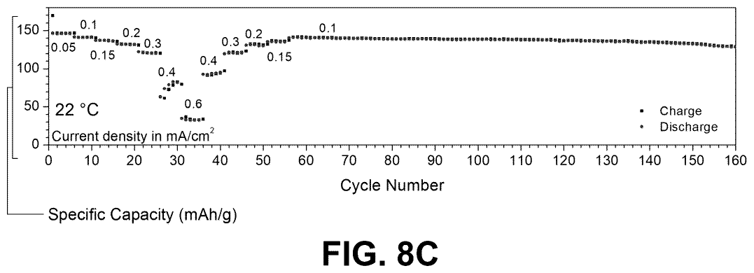

The limiting current density that a solid-state electrolyte can support influences practical applications. Both Li/Li and Li/LiFePO₄ cells were used to evaluate the limiting current density of the rigid polymer electrolyte. FIG. 8A shows the voltage profile of a Li/Li cell cycled at 22° C. at different current densities. Both charging and discharging time are 2 hours for each cycle and the current density increases from 0.025 to 0.3 mA cm⁻² with 5 cycles for each step. The slight voltage decrease after three cycles at 0.2 mA cm⁻² is likely caused by improved electrode/electrolyte contact. When the applied current density is below 0.3 mA cm⁻², the cell cycles stably. After 2.5 cycles (10 hours) at 0.3 mA cm⁻², the voltage increases drastically. Li/LiFePO₄ cells demonstrate similar results (FIGS. 8B and 8C). The thickness of the solid electrolyte used in this example is 130+20 μm, and the LiFePO₄ mass loading in the cathode is 3.6+0.4 mg cm⁻². Li/Li and Li/LiFePO₄ cycling tests reveal a limiting current density of ca. 0.3 mA cm⁻² and stable long-term cycling at 0.1 mA cm⁻² of the rigid polymer electrolyte at 22° C. Increasing the cycling current density from 0.05 to 0.3 mA cm⁻² leads to the specific capacity decreasing modestly from 150 to 120 mAh g⁻¹. Further increasing the current density causes significant polarization and rapid capacity decay. The limiting current density of an electrolyte also closely relates to its thickness. Under the same salt polarization, the attainable current density inversely scales with the thickness of the electrolyte. Since the rigid polymer electrolyte in this study is reasonably thick (130±20 μm) due to simple processing constraints, reducing its thickness to 25 μm should lead to a significant increase in limiting current density. Considering its superior mechanical properties over PEO-based dry polymer electrolytes, preparing a 25 μm membrane should be achievable by, e.g., spraying the electrolyte precursor solution directly onto the cathode to form a cathode-supported solid electrolyte.

Reversible cycling of solid-state batteries between ambient temperature and a significantly higher temperature will expand their practical applications, especially in electric vehicles. In recent years, many polymer electrolytes with wide working temperature windows have been reported. However, most of these studies only report cell performances while held static at each individual temperature, and no study has reported the cycling performance of a polymer electrolyte at ambient temperature after long-term cycling at an elevated temperature. High temperature cycling can potentially cause more side reactions at the electrode-electrolyte interface and/or mechanical swelling/distortions, thus deteriorating cell cycling performance when returned to ambient temperature. Here, in addition to studying the cell performance at high temperatures, continued cell cycling performance at ambient temperature after cycling at high temperatures is also reported, targeting fast charging at elevated temperatures and slower discharging at ambient temperature.

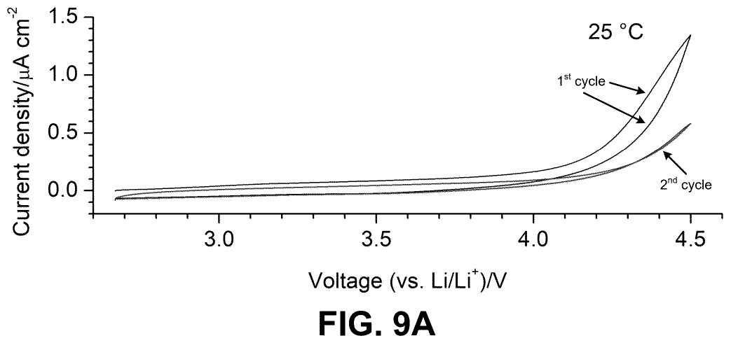

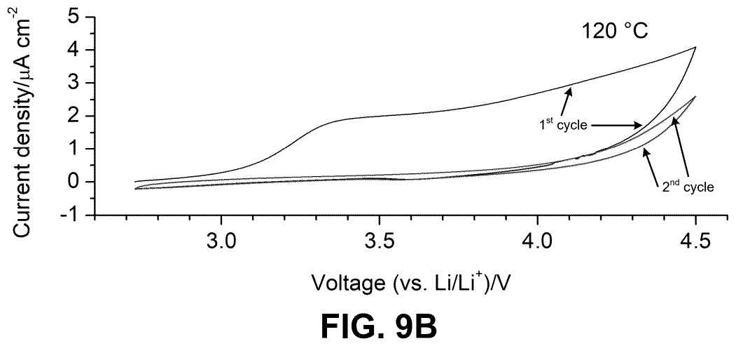

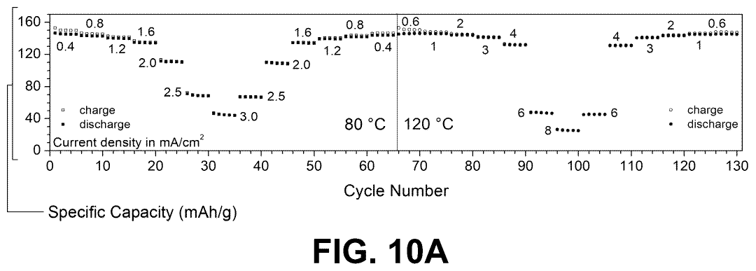

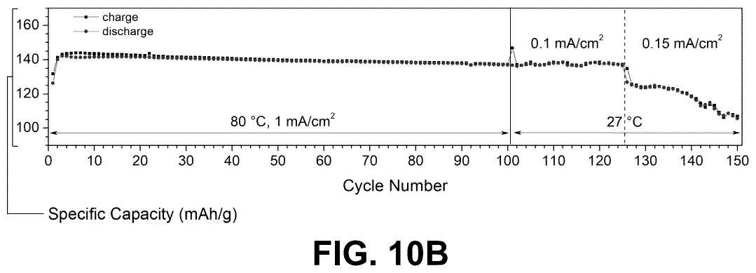

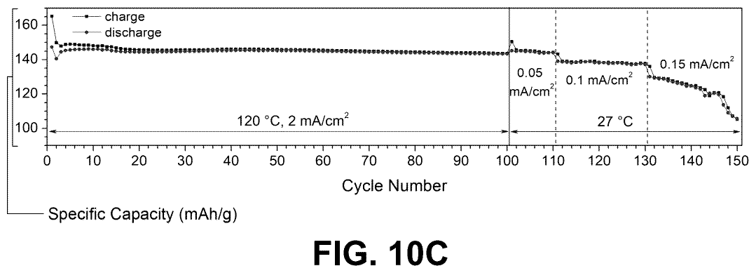

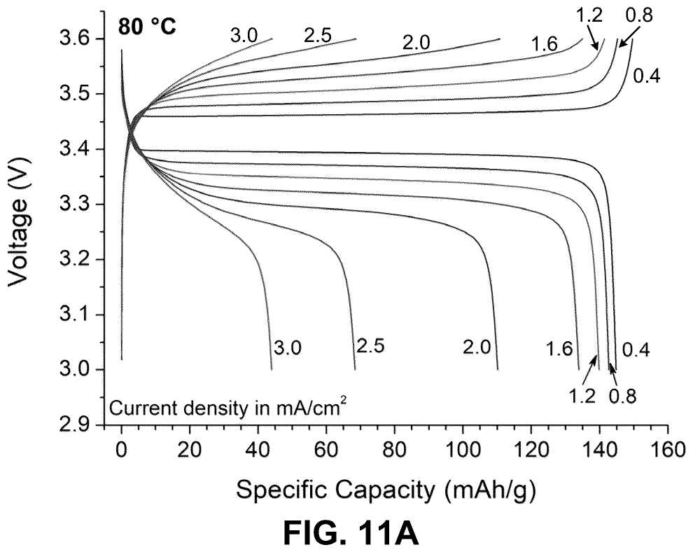

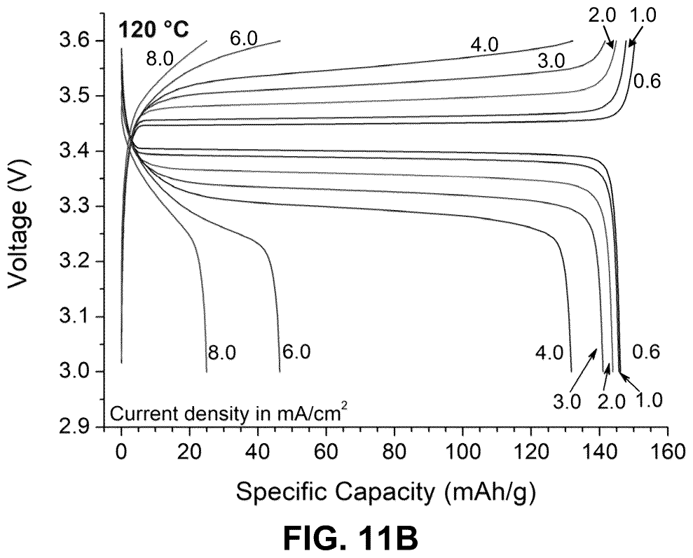

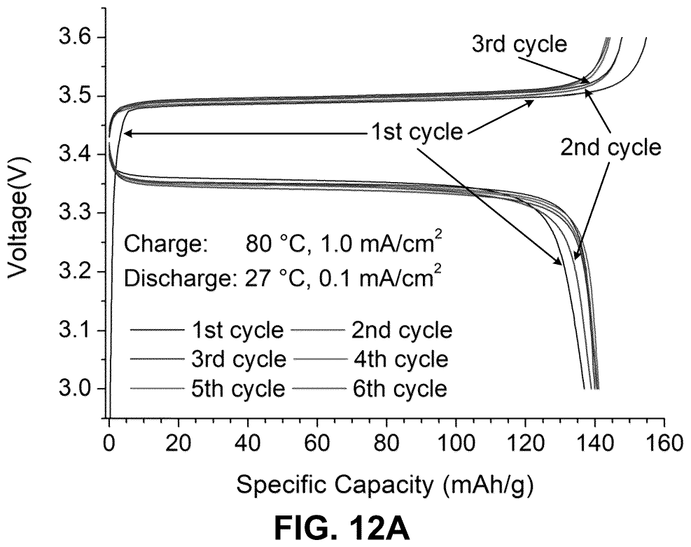

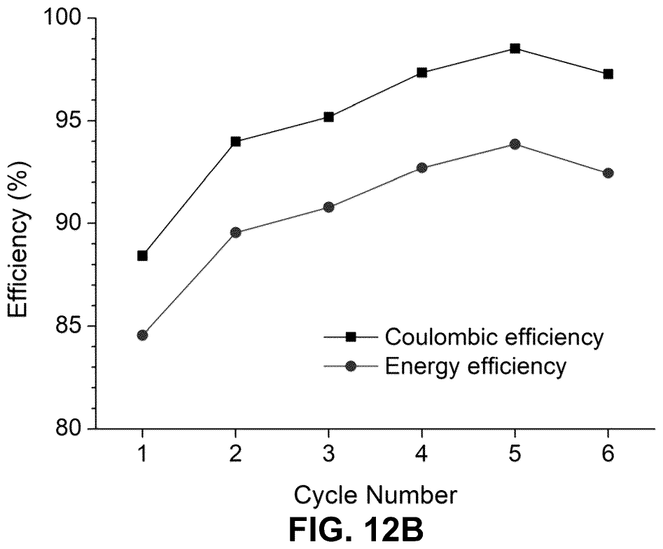

Cyclic voltammetry measurement indicates that the rigid gel polymer electrolyte has good electrochemical stability even at 120° C. (FIGS. 9A-9B). Thus, the rate capability of Li/LiFePO₄ cells is measured at 80° C. and 120° C. as shown in FIG. 10A. The voltage profiles are shown in FIG. 11A-11C. The upper voltage cutoff was set to 3.6 V for stable cycling performance. Increasing the cycling rate leads to a drop of capacity, but the capacity fully recovers when reducing the cycling rate. When cycling the cells at 80° C. using a current density of 2.0 mA cm⁻², the specific capacity remains 110 mAh g⁻¹. At 120° C., the specific capacity is as high as 130 mAh g⁻¹ even under a cycling current density of 4.0 mA cm⁻². The Li/LiFePO₄ cells also demonstrate long-term cycling stability at 80° C. and 120° C. under cycling current densities of 1.0 mA cm⁻² and 2.0 mA cm⁻², respectively, with <4% capacity decay after 100 cycles (FIGS. 10B-10C). These tests reveal cycling stability of the rigid polymer electrolyte both at elevated temperatures and after cooling to ambient temperature (27+1° C.). The Coulombic efficiency at 120° C. is 89.2% for the first cycle, and it gradually increases to above 99.1% after 20 cycles, likely caused by side reactions that may result from oxidation of impurities or PEO in the membrane. When the cells are cooled from 80° C. or 120° C. to ambient temperature, they still demonstrate stable cycling with a specific capacity close to 140 mAh g⁻¹ under a cycling current density of 0.1 mA cm⁻². Further increasing the current density to 0.15 mA cm⁻², the cells still demonstrate high specific capacity (>120 mAh g⁻¹) for more than 10 cycles. In order to further investigate this rigid polymer electrolyte for fast charging at high temperatures and slow discharging at ambient temperature, Li/LiFePO₄ cells are cycled by charging them at 80° C. using a current density of 1.0 mA cm⁻² and discharging them at 27° C. with 0.1 mA cm⁻². FIG. 12A shows 6 stable cycles of a cell with an average specific discharge capacity of 140 mAh g⁻¹. The average Coulombic efficiency and energy efficiency (FIG. 12B) from the second cycle to the sixth cycle are 96.5% and 91.9%, respectively. Overall, these cells demonstrate excellent cycling performance at 80° C. and 120° C., and with reversible cycling after cooling to ambient temperature.

Referring to FIGS. 9A-9B, the scan rate is 1 mV s⁻¹. Two cycles are shown for each temperature with the first cycle and second cycle indicated with arrows. Note that the unit of the current density is in μA cm⁻². The measured current density at 120° C. during the first cycle is high above 3.3 V but drops significantly during the second cycle suggesting that the electrolyte/electrode interface is passivated during the first cycle. The measured current at both 25° C. and 120° C. during the second cycle below 4.0 V is 3˜4 order of magnitudes smaller than the current density used to cycle the Li/Li or Li/LFP cell, indicating good anodic stability of the rigid polymer gel electrolyte.

### Methods—Materials.

PBDT was synthesized by an interfacial polycondensation reaction of terephthaloyl chloride and 2,2′-benzidinedisulfonic acid at the presence of Li₂CO₃. Aqueous solution of PBDT shows a transition from isotropic phase to nematic phase at 1.9 wt % PBDT. PEGDME (average Mₙ 500 g mol⁻¹) was purchased from Sigma-Aldrich. LiTFSI 98+% was purchased from Alfa Aesar. PBDT and LiTFSI were dried at 100° C. under vacuum overnight before use. The solid polymer electrolyte membrane was prepared using previously reported solvent casting methods. 0.160 g PBDT was dissolved in 16.0 g water. 0.566 g LiTFSI and 1.40 g PEGDME were dissolved in 8.00 g dimethylformamide. These two solutions were mixed together at 85° C. and equilibrated at 85° C. overnight. The mixed solution was then poured onto a 12×12 cm² glass substrate and dried at 85° C. on a hot plate for 24 hours. The solid polymer electrolyte membrane was peeled off the glass substrate and further dried in a vacuum oven at 100° C. and 6.5 kPa absolute air pressure for 0.5 hour before transferring to an Ar-filled glovebox immediately. The mass of the solid polymer electrolyte membrane was 2.04 g. The complete removal of dimethylformamide (to <0.1 wt %) was confirmed by ¹H NMR.

### Methods—Characterizations.

Thermogravimetric analysis was measured with a Discovery TGA550 in a dry N₂ atmosphere. The sample was first heated to 85° C. and dried for 3 minutes to remove any moisture picked up during sample preparation. The second heating trace with a rate of 10° C. min-1 was reported in FIG. 3. The second heating trace, with the temperature holding at 120° C., 150° C., and 180° C. each for 0.5 hour, was reported in FIG. 1C. Differential scanning calorimetry was measured with a TA Instruments DSC Q2000. The sample was first heated to 100° C. and dried for 5 minutes to remove any moisture absorbed during sample preparation. The sample was then cooled to −85° C. at a rate of 10° C. min⁻¹. The second heating trace with a rate of 10° C. min⁻¹ was reported. Dynamic mechanical analysis was measured on a Discovery DMA850. The sample was first heated to 150° C. for 3 minutes and the storage and loss moduli were measured while cooling the sample with a rate of 2° C. min-1 at an oscillation frequency of 1 Hz and a strain amplitude of 0.2%. Atomic force microscopy was conducted on a Veeco BioScope II instrument under tapping mode.

NMR was measured on a Bruker 400 MHz Avance III widebore spectrometer. Self-diffusion coefficients of the Li⁺, TFSI⁻, and PEGDME were obtained by measuring the ⁷Li, ¹⁹F, and ¹H nuclei using a 5 mm ¹H coil and a 5 mm ⁷Li/³¹P coil. The pulsed-gradient stimulated-echo sequence was used to measure the rigid polymer electrolyte and the pulsed-gradient double stimulated-echo sequence was used to measure the liquid electrolyte (LiTFSI dissolved in PEGDME). The effective gradient pulse duration (o) was set to 2.0 ms for all measurements. The diffusion time (Δ) was set to 50 ms for the measurements of TFSI⁻ and PEGDME, and 50 or 100 ms for the measurements of Lit. The maximum gradient strength (gₘₐₓ) varied from 170 to 2200 G cm⁻¹ based on the sample, temperature and measured nucleus. The mobility μ from ENMR for each species was measured in the same way as previously reported. For ENMR on TFSI⁻, δ=2 ms, Δ=20 ms, g=750 G cm⁻¹. For ENMR on Li⁺, δ=2 ms, Δ=20 ms, g=900 G cm⁻¹. For ENMR on PEGDME, δ=3.5 ms, Δ=30 ms, g=1200 G cm⁻¹. The ionic conductivity GEIS of the liquid electrolyte was measured simultaneously with ENMR measurement through EIS using a BioLogic SP-200 potentiostat. The measured conductivity by EIS and the conductivity derived from the sum of the measured electrophoretic mobilities of Li⁺ and TFSI⁻ (μ₊+μ₋) agree to within errors of each other. EIS for the rigid polymer electrolyte was measured by sandwiching the electrolyte membrane between two stainless steel plates inside a CR2032 coin cell. Electrochemical impedance spectra and DC polarizations were again conducted using the BioLogic SP-200 potentiostat.

The Li⁺ transference number t^{DC} determined from the DC polarization method was determined using the following equation:

$${t}^{DC} = \frac{{R}_{b}}{Δ V / {I}_{s} - {R}_{s}} \qquad ( 2 )$$

where R_{b} is the bulk resistance of the electrolyte, Rₛ is the interfacial resistance at steady state, Iₛ is the steady state current, and ΔV is the applied voltage bias (10 mV).

The Li⁺ transference number t^{DNMR} was determined based on the diffusion coefficients using equation:

$${t}^{DNMR} = \frac{{c}_{+} {D}_{+}}{{c}_{+} {D}_{+} + {c}_{-} {D}_{-}} \qquad ( 3 )$$

where c₊ and c₋ are the molar concentrations of Li⁺ and TFSI⁻, and D₊ and D₋ are the diffusion coefficients of Li⁺ and TFSI⁻.

The Li⁺ transference number t^{ENMR} was determined using the following equation:

$${t}^{ENMR} = \frac{{μ}_{+} - {μ}_{Solve}}{{μ}_{+} + {μ}_{-}} \qquad ( 4 )$$

where μ₊, μ₋, and μₛₒₗᵥ are the measured mobilities of Li⁺, TFSI⁻, and PEGDME, respectively in the laboratory frame.

The Onsager transport coefficients (σ₊₊, σ₋₋, σ₊₋) are determined using the following equations:

$${c}_{+} {μ}_{+} F = {σ}_{+ +} - {σ}_{+ -} \qquad ( 5 )$$

$$and$$

$${c}_{-} {μ}_{-} F = {σ}_{--} - {σ}_{+ -}$$

$${t}^{DC} = \frac{{σ}_{+ +} - ( \frac{{σ}_{+ -}^{2}}{{σ}_{--}} )}{{σ}^{EIS}} \qquad ( 6 )$$

where σ₊₊ and σ₋₋ further split into self-terms and distinct terms, and the self-terms relate to the diffusion coefficients through the Nernst-Einstein equations:

$${σ}_{+ +} = {σ}_{+}^{self} + {σ}_{+ +}^{dis} \qquad ( 7 )$$

$$and$$

$${σ}_{--} = {σ}_{-}^{self} + {σ}_{--}^{dis}$$

$${σ}_{+}^{self} = {c}_{+} {D}_{+} \frac{{F}^{2}}{RT} \qquad ( 8 )$$

$$and$$

$${σ}_{-}^{self} = {c}_{-} {D}_{-} \frac{{F}^{2}}{RT}$$

where F is the Faraday constant, R is the gas constant, and T is the temperature.

For battery cell tests, CR2032 coin cells were assembled using a MTI MSK-160E crimper inside an Ar-filled glovebox. Li metal was used as the anode, and LiFePO₄ cathodes with a LiFePO₄ mass loading of 3.6+0.4 mg cm⁻² from a previous study were used directly in this study. Cell cycling at 22° C. was conducted using a Neware CT-4008 T battery tester. Cell cycling at 27° C., 80° C., and 120° C. were collected using a Landt CT3002A battery tester. A Yamato DX600 oven was used to provide the 80° C. and 120° C. environment with an error of ±1° C. The 27° C. ambient temperature fluctuates within ±1° C. For the Li/LiFePO₄ cell cycling at 22° C., a constant current constant voltage charging and constant current discharging protocol was applied, and the charging process was stopped when the charging current dropped by 75%. For the Li/LiFePO₄ cell cycling at 27° C., 80° C., and 120° C., a galvanostatic charging and discharging protocol was applied. The lower voltage cutoff was set to 3.0 V for all the tests. The upper cutoff was set to 4.0 V when cycling cells at 22° C. and 27° C., and 3.6 V at 80° C. and 120° C. The cells were allowed to rest for at least 2 hours at each temperature before charging or discharging.

### CONCLUSIONS

Proposed in this example is a new approach to prepare low-cost ethylene oxide-based polymer electrolytes by immobilizing a liquid PEGDME electrolyte using the charged rigid-rod polymer PBDT. The formation of PBDT-rich nanofibrils endows this highly rigid gel polymer electrolyte (only 8 wt % PBDT) with superior thermomechanical properties (tensile strength and moduli over a wide temperature range) as compared to high molecular weight PEO-based dry polymer electrolyte. The mechanical properties of this rigid polymer electrolyte meets or exceeds the commercial Celgard separators in many aspects (tensile strength in the transverse direction, Young's modulus when immersed in electrolytes, modulus at elevated temperatures). Due to the low crystallization temperature of PEGDME and mechanical robustness at high temperatures, the working temperature window of this rigid polymer electrolyte greatly surpasses that of PEO-based electrolytes. The short chain length of PEGDME also ensures high ionic conductivity. The presence of PBDT only slows down ion transport by a factor of 2-3, which also outperforms commercial inert solid separators. Solid-state cell tests using the rigid polymer electrolyte with a thickness of 130+20 μm reveal a limiting current density of 0.3 mA cm⁻² at 22° C. Li/LiFePO₄ cells demonstrate great cycling stability at 80° C. and 120° C. under a cycling current density of 1.0 and 2.0 mA cm⁻², respectively. When the cells are cooled to ambient temperature from 80° C. and 120° C., they still show good cyclability. Preliminary tests indicate that Li/LiFePO₄ cells using the rigid polymer electrolyte as solid-state electrolyte is very promising for high temperature fast charging and ambient temperature slow discharging.

The current target for limiting current density of electrolytes in lithium batteries for electric vehicles is ˜10 mA cm⁻². Considering the robust mechanical properties of this rigid polymer electrolyte, this target can be reached at 80-100° C. simply by reducing its thickness to the same as commercial separators (≈20 μm) by applying mature industrial processing techniques. The studies of the Li⁺ transport mechanism and dynamic ion correlations further reveal that reducing LiTFSI content and PEGDME molecular weight can benefit lithium cell rate capability. Thus, this PBDT-based rigid polymer electrolyte represents a strong competitor for next-generation, solid-state batteries.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A gel polymer composition, comprising:
a first polymer comprising poly(ethylene glycol), poly(pentyl malonate), or a derivative thereof;
poly(2,2′-disulfonyl-4,4′-benzidine terephthalamide) (PBDT); and
a salt.

2. The gel polymer composition of claim 1, wherein the PBDT comprises PBDT nanofibrils.

3. The gel polymer composition of claim 1, wherein the salt is selected from a lithium salt, a sodium salt, and a combination thereof.

4. The gel polymer composition of claim 3, wherein the salt comprises a lithium salt selected from lithium bis(trifluoromethane)sulfonimide, lithium bis(fluorosulfonyl)imide, lithium trifluoromethanesulfonate, lithium difluoro (oxalato) borate, lithium difluorobis(oxalate) phosphate, lithium perchlorate, lithium dicyanamide, and a combination thereof.

5. The gel polymer composition of claim 3, wherein the salt comprises a sodium salt selected from sodium bis(trifluoromethane)sulfonimide, sodium bis(fluorosulfonyl)imide, sodium trifluoromethanesulfonate, sodium difluoro (oxalato) borate, sodium difluorobis(oxalate) phosphate, sodium dicyanamide, and a combination thereof.

6. The gel polymer composition of claim 1, wherein the first polymer has a number average molecular weight of about 150 g/mol to about 8000 g/mol.

7. The gel polymer composition of claim 1, wherein the first polymer comprises a poly(ethylene glycol) derivative selected from poly(ethylene glycol) dimethyl ether, poly(ethylene oxide), poly(oligo-oxyethylenemethacrylate), and a combination thereof.

8. The gel polymer composition of claim 1, wherein PBDT comprises from about 2 wt % to about 20 wt % of the total composition.

9. The gel polymer composition of claim 1, wherein first polymer comprises from about 50 wt % to about 80 wt % of the total composition.

10. The gel polymer composition of claim 1, wherein the salt comprises from about 10 wt % to about 50 wt % of the total composition.

11. The gel polymer composition of claim 1, wherein the composition has a tensile strength in the transverse direction of at least about 4 MPa, where the tensile strength is measured by stress-strain analysis at a temperature of about 30° C.

12. The gel polymer composition of claim 1, wherein the composition has a tensile storage modulus of greater than about 300 MPa at about 25° C., where the tensile storage modulus is measured at an oscillation frequency of 1 Hz and a strain amplitude of 0.2%.

13. The gel polymer composition of claim 1, wherein the composition has a tensile storage modulus of greater than about 200 MPa at about 150° C., where the tensile storage modulus is measured at an oscillation frequency of 1 Hz and a strain amplitude of 0.2%.

14. The gel polymer composition of claim 1, wherein a loss modulus of the composition is at least about 6 times lower than a storage modulus of the composition over a temperature range about 25° C. to about 150° C., where both the tensile storage modulus and the loss modulus are measured at an oscillation frequency of 1 Hz and a strain amplitude of 0.2%.

15. A method, comprising:
dissolving both a salt and a first polymer in a first solvent, thereby forming a first mixture, where the first polymer comprises poly(ethylene glycol), poly(pentyl malonate), or a derivative thereof;
dissolving poly(2,2′-disulfonyl-4,4′-benzidine terephthalamide) (PBDT) in a second solvent, thereby forming a second mixture;
combining the first mixture and the second mixture, thereby forming an intermediate mixture;
pouring the intermediate mixture onto a substrate;
drying the intermediate mixture and the substrate; and
removing the dried intermediate mixture from the substrate, thereby forming a polymer membrane.

16. The method of claim 15, further comprising drying the polymer membrane by vacuum drying.

17. A gel polymer composition produced by the method of claim 15.

18. An article comprising the gel polymer composition of claim 1.

19. The article of claim 18, wherein the article comprises a battery or a component of a battery.

20. An article comprising the gel polymer composition of claim 17.
